(19) United States
(12) Patent Application Publication
(10) Pub. No.: US 2008/0113260 A1
(43) Pub. Date: May 15, 2008

(54) PRISMATIC NONAQUEOUS ELECTROLYTE SECONDARY BATTERY AND METHOD FOR MANUFACTURING THE SAME

(75) Inventors: Kenji NANSAKA, Moriguchi-shi (JP); Yasutomo TANIGUCHI, Moriguchi-shi (JP); Yasuhiro YAMAUCHI, Moriguchi-shi (JP); Naoya NAKANISHI, Moriguchi-shi (JP); Toshiyuki NOHMA, Moriguchi-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 11/937,651

(22) Filed: Nov. 9, 2007

(30) Foreign Application Priority Data
Nov. 13, 2006 (JP) 2006-306916

(51) Int. Cl. H01M 10/36

(52) U.S. Cl. 429/94; 29/623.1

(57) ABSTRACT

A prismatic nonaqueous electrolyte secondary battery of the invention includes a process whereby a cylindrical electrode roll is produced by spirally rolling negative electrode plates made of elongated sheet-like negative electrode substrates to which is applied a negative electrode mixture containing negative electrode active material, and positive electrode plates made of elongated sheet-like positive electrode substrates to which is applied a positive electrode mixture containing positive electrode active material, insulated from each other by separators; and then the cylindrical electrode roll is crushed to be formed into a flattened electrode roll; the process of crushing the cylindrical electrode roll to form a flattened electrode roll being controlled so that, in the flattened electrode roll the ratio of change in the separator gas permeability between the winding start and the winding end is 55% or less of the gas permeability at the winding start. By providing such a configuration, a prismatic nonaqueous electrolyte secondary battery and a method for manufacturing the same can be obtained, in which gas permeability of separators does not increase during manufacturing of a flattened electrode roll thereby making possible to achieve a high discharge output.

### BACKGROUND

1. Technical Field

The present invention relates to a prismatic nonaqueous electrolyte secondary battery and a method for manufacturing the same, and more particularly to a prismatic nonaqueous electrolyte secondary battery and a method of manufacturing the same, in which gas permeability of separators does not increase during manufacturing of a flattened electrode roll, thereby making it possible to achieve a high discharge output.

2. Related Art

With the rapid spread of portable electronic devices, the specifications required of the batteries used in such devices are becoming more stringent every year, and particularly there is a need for batteries that are more compact and thinner, having high capacity, superior cycling characteristics, and stable performance. In the field of secondary batteries, attention is focused on lithium-based nonaqueous electrolyte secondary batteries, which have higher energy density than other batteries, and the share in the secondary battery market of lithium-based nonaqueous electrolyte secondary batteries is significantly growing.

In a device that uses this kind of nonaqueous electrolyte secondary battery, since the space for housing the battery often has an angular shape (flattened box shape), a prismatic nonaqueous electrolyte secondary battery, which houses its power generating elements in a prismatic case, is often used. Such a prismatic nonaqueous electrolyte secondary battery is, for example, made as follows.

A cylindrical electrode roll is made as follows: First, separators composed of such things as microporous polyethylene film are disposed between negative electrode plates and positive electrode plates, in which the former are negative electrode substrates (collector) composed of such things as elongated sheet-like copper foil to whose both faces is applied a negative electrode mixture containing negative electrode active material, and the latter are positive electrode substrates composed of such things as elongated sheet-like aluminum foil to whose both faces is applied a positive electrode mixture containing positive electrode active material; then the negative electrode plates and positive electrode plates insulated from each other by the separators are rolled into a spiral form around a cylindrical winding core. Subsequently, the cylindrical electrode roll is crushed by a press to be formed into a flattened electrode roll that can be inserted into a prismatic battery case, and then housed in the prismatic case, into which electrolyte is poured to make a prismatic nonaqueous electrolyte secondary battery.

The configuration of such a related-art prismatic nonaqueous electrolyte secondary battery is described using the drawings. FIG. 2 is a cross-sectional view of a prismatic nonaqueous electrolyte secondary battery. This nonaqueous electrolyte secondary battery 10 has a flattened electrode roll 11 in which positive electrode plates (not shown in the drawings) and negative electrode plates (not shown in the drawings) are rolled up with separators (not shown in the drawings) interposed between them, and which is housed inside a prismatic battery case 12, which is then sealed by a sealing plate 13.

The flattened electrode roll 11 is provided at both ends in the direction of the winding axis with a positive electrode substrate exposed portion 14 and a negative electrode substrate exposed portion 15 to which positive or negative electrode mixture is not applied. The positive electrode substrate exposed portion 14 is connected to a positive electrode terminal 17 through a positive electrode collector 16; the negative electrode substrate exposed portion 15 is connected to a negative electrode terminal 19 through a negative electrode collector 18. The positive electrode terminal 17 and the negative electrode terminal 19 are secured to the sealing plate 13 through insulating members 20 and 21, respectively,

This prismatic nonaqueous electrolyte secondary battery is made by laser-welding the sealing plate 13 to the mouth of the battery case 12 after inserting the flattened electrode roll 11 into the battery case 12, then pouring nonaqueous electrolyte through an electrolyte pouring hole (not shown in the drawings), and finally sealing the electrolyte pouring hole. Such a prismatic nonaqueous electrolyte secondary battery produces a superior advantage in that the battery wastes little space when used, while having a high performance and reliability.

In such nonaqueous electrolyte secondary batteries, used as a positive electrode active material is lithium-transition metal composite oxide represented as LiₓMO₂ (where M represents at least one of Co, Ni or Mn), which can reversibly intercalate/deintercalate lithium ions; that is, one or mixture of more than one of LiCoO₂, LiNiO₂, LiNi_{y}CO_{1-y}O₂ (y=0.01 to 0.99), LiMnO₂, LiMn₂O₄, LiCoₓMn_{y}Ni_{z}O₂ (x+y+z=1), and LiFePO₄ is used. As a negative electrode active material, carbonaceous material such as graphite or amorphous carbon is generally used.

As a nonaqueous solvent (organic solvent) used in nonaqueous electrolyte secondary batteries, for reasons that a high dielectric constant is required to ionize electrolyte and that a high ionic conductivity is required in a wide temperature range, organic solvent such as carbonates, lactones such as gamma-butyrolactone, or other such as ethers, ketones, or esters is used.

The separator used in the above-mentioned nonaqueous electrolyte secondary battery is known to greatly influence the battery characteristics and safety. To describe specifically, in normal use of the nonaqueous electrolyte secondary battery, this separator needs to be able to maintain a battery voltage even under high-load conditions by suppressing the electric resistance with its porous structure, as well as to prevent a short circuit between positive and negative electrodes, while in case of a rise in battery temperature due to a high current in the nonaqueous electrolyte secondary battery caused by external short circuit or erroneous connection there is required a shutdown function, in which the battery increases the electric resistance by becoming virtually nonporous while maintaining its predetermined length and width dimensions to stop its battery reaction, resulting in suppression of excessive temperature rise in the battery. Therefore, as a separator for the nonaqueous electrolyte secondary battery, a microporous membrane mainly made of polyethylene resin or a microporous membrane mainly made of polypropylene resin is often used (see JP-A-8-244152 and JP-A-2002-279956).

As already described, the flattened electrode roll used in the prismatic nonaqueous electrolyte secondary battery is made by making a cylindrical electrode roll, and then crushing it using a press to form it into a flattened electrode roll that can be inserted into the prismatic battery case. In this process of crushing by a press, in consideration of the speed-up of the electrode roll forming process and mounting efficiency of the electrode roll, there has been adopted a method in which the electrode roll is pressed at a constant pressure as well as heated at a constant temperature for a constant time (see JP-A-2002-246069). Also known is a method of manufacturing prismatic batteries, in which a flattened electrode roll is made at first by using a winding core with an elliptic cross section, and, before inserted into the battery case, the flattened electrode roll is compression-formed at a high temperature to obtain an increased battery capacity (see JP-A-10-302827).

In JP-A-8-339818, it is shown that a prismatic nonaqueous electrolyte secondary battery with improved high-rate discharge characteristics and cycling characteristics is obtained when the gas permeability of separators in the pressed flattened electrode roll is made in the range of 110% to 150%, assuming the gas permeability of separators in the cylindrical electrode roll as 100%. However, generally, the more strongly the cylindrical electrode roll is pressed to obtain the flattened electrode roll the more the battery performance is reduced. This is because the gas permeability of separators becomes too large, leading to the reduction of ion permeability.

To avoid such a phenomenon, it is effective to perform a press forming in thermoforming at a low compression ratio or low temperature. However, there occur inconveniences such that the flattened electrode roll cannot be inserted into the battery case because the thickness of the flattened electrode roll increases after forming.

### SUMMARY

As a result of detailed study on such physical properties of the separator when the cylindrical electrode roll is crushed by a press, the inventors have found that the gas permeability of the separator does not change uniformly between a winding start and a winding end, but the gas permeability is increased much more at the winding end than at the winding start, and this increase of the permeability at the winding end leads to a deterioration of battery performance.

Therefore, as a result of further study to obtain a method for suppressing the increase in the separator permeability at the winding end of the flattened electrode roll after press forming, the inventors have found that a nonaqueous electrolyte secondary battery that achieves a high discharge output can be obtained if the ratio of change in the separator gas permeability between the winding start and the winding end is within a given range, thus completing the present invention.

That is, an advantage of some aspects of the present invention is to provide a prismatic nonaqueous electrolyte secondary battery and a method for manufacturing the same, in which gas permeability of separators does not increase during manufacturing of a flattened electrode roll thereby making possible to achieve a high discharge output.

The above-mentioned advantage of the present invention can be achieved by the following configuration. Specifically, according to an aspect of the present invention, a prismatic nonaqueous electrolyte secondary battery is provided with a flattened electrode roll in which a negative electrode plate and a positive electrode plate insulated from each other by a separator is rolled into a spiral form. The negative electrode plate is made of an elongated sheet-like negative electrode substrate to which is applied a negative electrode mixture containing negative electrode active material; the positive electrode plate is made of an elongated sheet-like positive electrode substrate to which is applied a positive electrode mixture containing positive electrode active material. In the flattened electrode roll a ratio of change in separator gas permeability between a winding start and a winding end (hereinafter called simply “gas permeability change ratio”) is 55% or less of the gas permeability at the winding start.

The “gas permeability” in the present invention is a measurement according to the measurement method specified by JIS P8117 and is measured as a time (in seconds) required for a given volume of gas to pass through a separator. Therefore, the gas permeability of little clogged separator is small because gas easily passes, and the gas permeability of much clogged separator is large because gas is difficult to pass. The “gas permeability change ratio” in the present invention is defined as the following formula.

Gas permeability change ratio (%)=100×(Gas permeability at winding end−Gas permeability at winding start)/Gas permeability at winding start

According to another aspect of the invention, a method for manufacturing the prismatic nonaqueous electrolyte secondary battery includes: a process whereby a cylindrical electrode roll is made by spirally rolling a negative electrode plate made of an elongated sheet-like negative electrode substrate to which is applied a negative electrode mixture containing negative electrode active material, and a positive electrode plate made of an elongated sheet-like positive electrode substrate to which is applied a positive electrode mixture containing positive electrode active material, insulated from each other by a separator, and a following process whereby the cylindrical electrode roll is crushed to be formed into a flattened electrode roll. In this method, the process whereby the cylindrical electrode roll is crushed to be formed into a flattened electrode roll is controlled so that, in the flattened electrode roll a ratio of change in separator gas permeability between a winding start and a winding end is 55% or less of the gas permeability at the winding start.

Preferably, in the method for manufacturing the prismatic nonaqueous electrolyte secondary battery, the process whereby the cylindrical electrode roll is crushed to be formed into a flattened electrode roll is controlled so that a compression ratio of the separator is 15% or less.

Preferably, in the method for manufacturing the prismatic nonaqueous electrolyte secondary battery, the process whereby the cylindrical electrode roll is crushed to be formed into a flattened electrode roll is performed under a condition that the cylindrical electrode roll has a temperature lower than 30° C.

Preferably, in the method for manufacturing the prismatic nonaqueous electrolyte secondary battery, the cylindrical electrode roll has a portion wound only by the separators that are extended from the winding end of the positive and negative electrode plates by 2% to 10%, inclusive, of the design thickness of the flattened electrode roll.

By adopting the above-mentioned method of manufacturing, the present invention produces superior advantages as described below. Specifically, according to the prismatic nonaqueous electrolyte secondary battery of the above features, since, in the flattened electrode roll, the ratio of change in the separator gas permeability between the winding start and the winding end is 55% or less of the gas permeability at the winding start, a prismatic nonaqueous electrolyte secondary battery with a low internal resistance and a high discharge output is obtained.

Further, according to the method for manufacturing the prismatic nonaqueous electrolyte secondary battery of the above features, when manufacturing the flattened electrode roll by crushing the cylindrical electrode roll, since the process forming the flattened electrode roll is controlled so that, in the flattened electrode roll, the ratio of change in the separator gas permeability between the winding start and the winding end is 55% or less of the gas permeability at the winding start, a prismatic nonaqueous electrolyte secondary battery with a low internal resistance and a high discharge output can be manufactured. If the gas permeability change ratio exceeds 55%, it is unfavorable since the internal resistance increases in proportion to the increasing ratio of the gas permeability change ratio, resulting in the reduction of discharge output.

Further, according to the method for manufacturing the prismatic nonaqueous electrolyte secondary battery of the above features, by controlling the process whereby the cylindrical electrode roll is crushed to be formed into a flattened electrode roll so that the compression ratio of the separators becomes 15% or less, it can be easily accomplished to obtain the flattened electrode roll in which the ratio of change in the separator gas permeability between the winding start and the winding end is 55% or less of the gas permeability at the winding start.

Further, according to the method for manufacturing the prismatic nonaqueous electrolyte secondary battery of the above features, since the process whereby the cylindrical electrode roll is crushed to be formed into a flattened electrode roll is performed particularly under the condition that the temperature of the cylindrical electrode roll is lower than 30° C. without preheat, the separator gas permeability does not increase, and thus the separator gas permeability can easily be controlled within a given numerical range.

After completion of the process whereby the cylindrical electrode roll is crushed to be formed into a flattened electrode roll, the separator gas permeability becomes higher toward the winding end. However, according to the method for manufacturing the prismatic nonaqueous electrolyte secondary battery of the present invention, since separators are extended from the winding end of the positive and negative electrode plates to form a portion wound only by the separators, the portion of the increased separator gas permeability is concentrated in the portion wound only by the separators. Therefore, since the separator gas permeability in the opposed part of the positive and negative electrode plates does not excessively rise and the portion of the increased separator gas permeability becomes hardly existing in the flattened electrode roll a prismatic nonaqueous electrolyte secondary battery with a lower internal resistance and a higher discharge output is obtained, compared with a related-art example.

Further, according to the method for manufacturing the prismatic nonaqueous electrolyte secondary battery of the present invention, by making the thickness of the portion wound only by separators to be 2% to 10%, inclusive, of the design thickness of the flattened electrode roll particularly the effect of the above-mentioned improvement in discharge output characteristics becomes remarkable. If the thickness of the portion wound only by separators is less than 2% of the design thickness of the flattened electrode roll it is unfavorable since the separator gas permeability in the vicinity of the winding end of the flattened electrode roll becomes large, resulting in an increase of the internal resistance leading to a deterioration of the discharge output characteristics. If the thickness of the portion wound only by separators exceeds 10% of the design thickness of the flattened electrode roll, it is also unfavorable since the effect of the improvement in discharge output characteristics is saturated, and moreover, formability and productivity in the pressing process deteriorate.

### BRIEF DESCRIPTION OF THE DRAWINGS

The invention will be described with reference to the accompanying drawings, wherein like numbers reference like elements.

FIG. 1 is a drawing to explain the form of a flattened electrode roll according to the second embodiment; FIG. 1A being a plan view and FIG. 1B being a front view.

FIG. 2 is a cross-sectional view of a prismatic nonaqueous electrolyte secondary battery in an example of the related art.

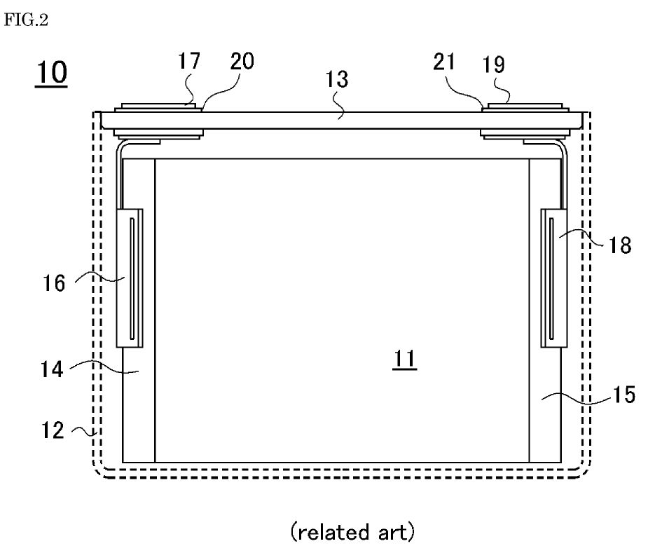

### DESCRIPTION OF EXEMPLARY EMBODIMENTS

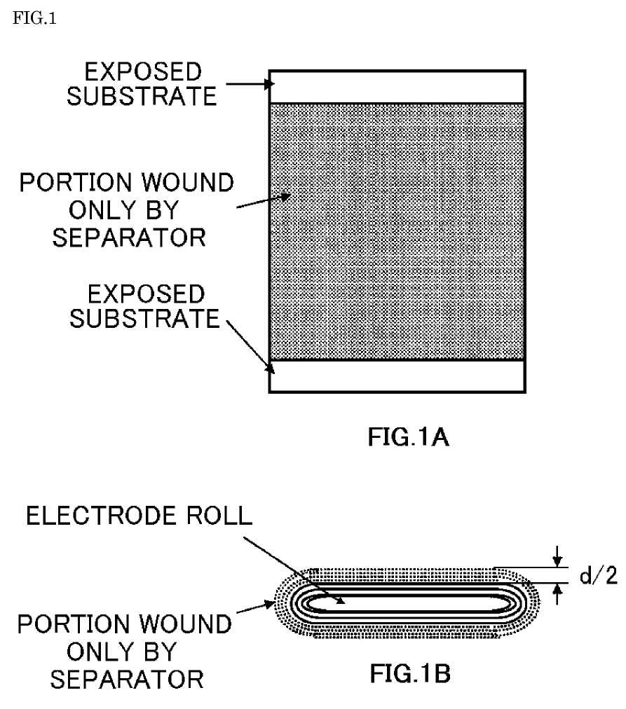

With reference to the drawings, exemplary embodiments will be described below along with comparative examples. It should be noted, however, that the embodiments described below are given to illustrate a method for manufacturing a prismatic nonaqueous electrolyte secondary battery to realize the concept of the present invention, and not to limit the invention to this particular method for manufacturing a prismatic nonaqueous electrolyte secondary battery; other embodiments included in the claims equally apply to the present invention. FIG. 1 is a drawing to explain the form of the flattened electrode roll according to the second embodiment; FIG. 1A being a plan view and FIG. 1B being a front view.

First, as common methods for the embodiments and the comparative example, the specific method for manufacturing a nonaqueous electrolyte secondary battery and the measurement methods of various characteristics will be explained.

### Making of Positive Electrode Plates

A positive electrode mixture was prepared by mixing a 94% mass fraction of lithium cobalt oxide (LiCoO₂) powder as a positive electrode active material and a 3% mass fraction of carbonaceous powder, such as acetylene black or graphite, as an electrically conductive agent. By kneading the mixture of this positive electrode mixture and a binder solution that was made by dissolving a 3% mass fraction of a binder made of polyvinylidene-fluoride in an organic solvent made of N-methyl-2-pyrrolidone (NMP), a positive electrode active material slurry was prepared.

What can be used as an alternative positive electrode active material slurry to the above-mentioned LiCoO₂ is lithium-transition metal composite oxide represented as LiₓMO₂ (where M represents at least one of Co, Ni or Mn, and 0.45≦x≦1.20), which can reversibly intercalate/deintercalate lithium ions; for example, one or mixture of more than one of LiNiO₂, LiNi_{y}Co_{1-y}O₂ (0.01≦y≦0.99), LiMnO₂, LiMn₂O₄, LiCoₓMn_{y}Ni_{z}O₂ (x+y+z=1), and LiFePO₄ can be used.

Next, positive electrode substrates composed of aluminum foil (for example, with a thickness of 20 μm) were provided, and by uniformly applying the positive electrode active material slurry made as the above to the positive electrode substrates, positive electrode mixture layers were formed. In this case, on the upper side of the positive electrode mixture layer, the positive electrode active material slurry was applied so that uncoated portions (positive electrode substrate exposed portions), to which the positive electrode active material slurry was not applied, of a given width (10 mm in this case) were formed along the edges of the positive electrode substrate. After that, the positive electrode substrates formed with the positive electrode mixture layers were passed through the inside of a drying machine to be dried and removed of the NMP that had been necessary to make the slurry. After drying, the substrates were rolled to a thickness of 0.06 mm by a roll press to make positive electrode plates. The positive electrode plates made in this manner were cut to a strip shape with a width of 100 mm, to obtain positive electrode plates provided with belt-shaped positive electrode substrate exposed portions of a width of 10 mm.

### Making of Negative Electrode Plates

A negative electrode active material slurry was prepared by mixing a 98% mass fraction of natural graphite powder as a negative electrode active material, and mass fractions of 1% each of carboxymethylcellulose (CMC) and styrene-butadiene rubber (SBR) as binders, then by adding water, and finally by kneading the mixture. What can be used as an alternative negative electrode active material slurry to the above-mentioned natural graphite is carbonaceous material, which can selectively intercalate/deintercalate lithium ions; for example, artificial graphite, carbon black, coke, glassy carbon, carbon fiber, or their burned substance can be used. In addition, also can be used are such materials as metallic lithium, lithium alloys including lithium-aluminum alloy, lithium-lead alloy, and lithium-tin alloy, and metal oxide, including SnO₂, SnO, TiO₂, and Nb₂O₃, with an electric potential less noble than positive electrode active material.

Next, negative electrode substrates composed of copper foil (for example, with a thickness of 12 μm) were provided, and by uniformly applying the negative electrode active material slurry made as the above to the negative electrode substrates, negative electrode mixture layers were formed. In this case, on the lower side of the negative electrode mixture layer, the negative electrode active material slurry was applied so that uncoated portions (negative electrode substrate exposed portions), to which the negative electrode active material slurry was not applied, of a given width (8 mm in this case) were formed along the edges of the negative electrode substrate. After that, the negative electrode substrates formed with the negative electrode mixture layers were passed through the inside of a drying machine to be dried. After drying, the substrates were rolled to a thickness of 0.05 mm by a roll press to make negative electrode plates. The negative electrode plates made in this manner were cut to a strip shape with a width of 110 mm, to obtain negative electrode plates provided with belt-shaped negative electrode substrate exposed portions of a width of 8 mm.

### Making of Electrode Roll

Next, belt-shaped separators (with a thickness of 0.022 mm and a width of 100 mm) composed of laminated structure of polyethylene and polypropylene were provided, then the positive electrode plates and negative electrode plates made as the above were disposed on the separators, and, displacing the plates in the widthwise direction, the separators, positive electrode plates, and negative electrode plates were superposed on each other so that the widthwise centerlines of their coated portions coincide. In this way, a positive electrode substrate exposed portion and a negative electrode substrate exposed portion extend out of the both edges of the separator.

After that, these items were rolled into a spiral form by a winder, and the outermost circumference was secured with tape to make a cylindrical electrode roll. The extra length of the separator was set to a half circumference from the winding end of the cylindrical electrode roll in cases of the first, second, and fourth embodiments, and the first comparative example. In case of the third embodiment, the extra length of the separator from the winding end of the cylindrical electrode roll was set so that the thickness d of the portion wound only by separators was equal to 2% of the design thickness of the flattened electrode roll (equal to a clearance W between upper mold and lower mold of a pressing device). In both cases, the outermost circumferential separator was secured with tape. The electrode roll produced in this manner has, at one end, the positive electrode substrate exposed portion of positive electrode plates extends out of one edge of the separators, and at the other end, the negative electrode substrate exposed portion of negative electrode plates extends out of the other edge of the separators. FIG. 1 shows the shapes of the parts of the flattened electrode roll obtained in the second embodiment.

Next, in case of the fourth embodiment, the cylindrical electrode roll was preheated to a temperature of 50° C.; however, it was not preheated in cases of the first, second, and third embodiments, and the first comparative example. After that, the clearance W between upper mold and lower mold of a pressing device was set so that the compression ratio of the separators becomes 15% first embodiment) or 24% (second to fourth embodiments or first comparative example), then the temperature and forming time of these molds were set as shown in Table 1, and finally the electrode roll was formed at a pressure of 0.6 MPa. The thickness L of the flattened electrode roll after forming was measured with a micrometer, and a thickness recovery ratio was obtained based on the following formula. To make it easy to insert the flattened electrode roll into a battery case, it is preferable to have the thickness recovery ratio of 6% or less. The results are shown in Table 1.

Thickness recovery ratio (%)=100×(L−W)/W

The adjustment of the compression ratio of the separators was performed as follows. Denoting the thickness of the separator as a, the number of the separator layers as A, the thickness of the positive electrode plate as b, the number of the positive electrode plate layers as B, the thickness of the negative electrode plate as c, and the number of the negative electrode plate layers as C, the thickness D of the cylindrical electrode rolls opposed part of the positive and negative electrode plates where electrode reaction occurs through the separator is given by

D=a·A+b·B+c·C

### Here, the clearance between upper mold and lower mold of a pressing device to obtain a separator compression ratio of s (%) denoted as D′ is given by

D′=D·a·A·s/100

### Therefore, the separator compression ratio s is represented as

s=(D−D′)·100/(a·A)

### Thus, the separator compression ratio s can be set by changing the clearance between upper mold and lower mold of a pressing device D′, which is a variable.

In addition, the flattened electrode roll after forming was disassembled, and with respect to the separators in each case of the embodiments and the comparative example, the winding start portion and winding end portion of the opposed part of the positive and negative electrode plates where electrode reaction occurs were measured for their gas permeability according to the measurement method specified by JIS P8117. Then, gas permeability change ratios were obtained based on the following formula. The results are collectively shown in Table 1.

Gas permeability change ratio (%)=100×(Gas permeability at winding end−Gas permeability at winding start)/Gas permeability at winding start

Collectors were attached to the positive electrode substrate exposed portion and the negative electrode substrate exposed portion of an electrode body in each of the embodiments and the comparative example, and the collectors were connected to terminals attached to sealing plates. Then, after inserting the electrode body into the battery case and welding the mouth of the case and the sealing plate, a given amount of nonaqueous electrolyte was poured through a pouring hole and the hole was plugged; thus, the prismatic nonaqueous electrolyte secondary batteries of the embodiments and the comparative example were produced. The dimensions of all batteries obtained were 90 mm×110 mm×10 mm, and the design capacity was 5 Ah. A mixed solvent of ethylene carbonate and methyl ethyl carbonate mixed at a volume ratio of 3:7 (at 25° C.) was prepared, in which LiPF6 and vinylene carbonate were dissolved to be 1 mol/L and 1% mass fraction, respectively; this solution was used as a nonaqueous electrolyte.

The internal resistances of the prismatic nonaqueous electrolyte secondary batteries produced in this manner in the embodiments and the comparative example were measured by the alternating current impedance method. The results are collectively shown in Table 1. Further, the prismatic nonaqueous electrolyte secondary batteries obtained in the embodiments and the comparative example were charged with a charging current of 1 It at 25° C. up to each charge depth, and in that state, charge and discharge operations were performed for 10 seconds each with currents of (⅓) It, 1 It, 3 It, and 5 It, respectively. The voltage of each battery was measured at that time, and plotting the currents and the battery voltages, the I-V characteristics of the discharge was obtained. (The plotted points represent a linear, first-order, or second-order approximation curve.) Then, the value of current I at the voltage V=3 V was read out, and the discharge output was obtained as W=V×I. The results are collectively shown in Table 1.

TABLE 1

| | | | | Thickness | | Separator | | | | | |
|---|---|---|---|---|---|---|---|---|---|---|---|
| | Forming conditions | | | of portion | | gas | | Gas | | | |
| | Separator | | | wound | | permeability | | permeability | Thickness | | |
| | compression | | | only by | | (s/100 mL) | | change | recovery | Internal | Discharge |
| | ratio | Temperature | Time | separators | | Winding | Winding | ratio | ratio | resistance | output |
| | (%) | (° C.) | (s) | (%) | Preheat | start | end | (%) | (%) | (mΩ) | (W) |
| First | 24 | 50 | 30 | 0 | No | 871 | 2124 | 143 | 3.1 | 1.316 | 665 |
| comparative | | | | | | | | | | | |
| example | | | | | | | | | | | |
| First | 15 | 50 | 600 | 0 | No | 650 | 850 | 31 | 2.8 | 1.109 | 787 |
| embodiment | | | | | | | | | | | |
| Second | 24 | 25 | 600 | 0 | No | 597 | 914 | 53 | 3.7 | 1.168 | 762 |
| embodiment | | | | | | | | | | | |
| Third | 24 | 50 | 30 | 2 | No | 641 | 934 | 46 | 2.3 | 1.072 | 795 |
| embodiment | | | | | | | | | | | |
| Fourth | 24 | 50 | 15 | 0 | Yes | 759 | 912 | 20 | 4.2 | 1.083 | 763 |
| embodiment | | | | | (50° | | | | | | |
| | | | | | C.) | | | | | | |

From the results shown in Table 1, the following are understood. Specifically, in both batteries obtained in the first and second embodiments, the separator gas permeability change ratio is 55% or less, and the thickness recovery ratio of the batteries is as small as 3% or less. As a result, in the batteries obtained in the first and second embodiments, the internal resistance is as small as 1.109 mΩ and 1.072 mΩ, respectively, and the discharge output is as large as 787 W and 795 W, respectively. Compared with this, in the battery obtained in the first comparative example, since the gas permeability at the winding end is very large and the gas permeability change ratio exceeds 100%, the internal resistance is as large as 1.316 mΩ, and the discharge output is as small as 665 W.

Comparing the results between the first comparative example and the first embodiment, it is found that by making the separator compression ratio small, the ratio of change in the separator gas permeability between the winding start and the winding end does not become large, achieving a small internal resistance and thus a high discharge output. Comparing also the results between the comparative example and the second embodiment, it is found that by increasing the forming time and reducing the temperature of upper and lower molds of a pressing device during forming, the ratio of change in the separator gas permeability between the winding start and the winding end does not become large, achieving a small internal resistance and thus a high discharge output.

Further, comparing the results between the first comparative example and the third embodiment, it is found that, despite the same forming conditions, the battery of the third embodiment has smaller values of separator gas permeability, separator gas permeability change ratio, and thickness recovery ratio, which result in reducing the internal resistance and increasing the discharge output. Therefore, it is found that, when the cylindrical electrode roll has a portion wound only by separators that are extended from the winding end of the positive and negative electrode plates, the portion of the increased separator gas permeability in forming is produced largely in the portion wound only by the separators, resulting in elimination of adverse effect to battery characteristics.

When the thickness of such a portion wound only by the separators is 2% or more of the design thickness of the flattened electrode roll, a sufficient effect of improvement in discharge output characteristics is observed, and the discharge output is recognized to increase with the increase of the thickness of the portion wound only by the separators. However, when the thickness of the portion wound only by separators approaches 10% of the design thickness of the flattened electrode roll the discharge output is little increased and becomes saturated.

The fourth embodiment is a case in which the cylindrical electrode roll is preheated in advance to 50° C. and formed. This embodiment has a short forming time, and compared with the first comparative example, small gas permeability change ratio and internal resistance, as well as a large discharge output.

As described above, according to the prismatic nonaqueous electrolyte secondary battery manufactured by the method of the present invention a prismatic nonaqueous electrolyte secondary battery is obtained that can have a small change in the separator gas permeability between the winding start and the winding end, a low internal resistance, and a high discharge output.

What is claimed is:

1. A prismatic nonaqueous electrolyte secondary battery comprising:
a flattened electrode roll in which a negative electrode plate made of an elongated sheet-like negative electrode substrate to which is applied a negative electrode mixture containing negative electrode active material, and a positive electrode plate made of an elongated sheet-like positive electrode substrate to which is applied a positive electrode mixture containing positive electrode active material, insulated from each other by a separator is rolled into a spiral form;
in the flattened electrode roll a ratio of change in separator gas permeability between a winding start and a winding end being 55% or less of the gas permeability at the winding start.

2. A method for manufacturing a prismatic nonaqueous electrolyte secondary battery, the method comprising:
making a cylindrical electrode roll by spirally rolling a negative electrode plate made of an elongated sheet-like negative electrode substrate to which is applied a negative electrode mixture containing negative electrode active material, and a positive electrode plate made of an elongated sheet-like positive electrode substrate to which is applied a positive electrode mixture containing positive electrode active material, insulated from each other by a separator; and
crushing the cylindrical electrode roll to form a flattened electrode roll;
the crushing the cylindrical electrode roll to form a flattened electrode roll being controlled so that, in the flattened electrode roll, a ratio of change in separator gas permeability between a winding start and a winding end is 55% or less of the gas permeability at the winding start.

3. The method for manufacturing a prismatic nonaqueous electrolyte secondary battery according to claim 2, wherein the crushing the cylindrical electrode roll to form a flattened electrode roll is controlled so that a compression ratio of the separator becomes 15% or less.

4. The method for manufacturing a prismatic nonaqueous electrolyte secondary battery according to claim 2, wherein the crushing the cylindrical electrode roll to form a flattened electrode roll is performed under a condition that the cylindrical electrode roll has a temperature lower than 30° C.

5. The method for manufacturing a prismatic nonaqueous electrolyte secondary battery according to claim 2, wherein the cylindrical electrode roll has a portion wound only by the separators that are extended from the winding end of the positive and negative electrode plates by 2% to 10%, inclusive, of the design thickness of the flattened electrode roll.
